(19) United States
(12) Patent Application Publication
(10) Pub. No.: US 2025/0210624 A1
(43) Pub. Date: Jun. 26, 2025

(54) POSITIVE ELECTRODE FOR LITHIUM-SULFUR BATTERY COMPRISING TWO TYPES OF CONDUCTIVE MATERIALS AND LITHIUM ION SECONDARY BATTERY COMPRISING THE SAME

(71) Applicant: LG ENERGY SOLUTION, LTD., Seoul (KR)

(72) Inventors: Bong-Soo KIM, Daejeon (KR); Il-To KIM, Daejeon (KR); Myeong-Jun SONG, Daejeon (KR); Ji-Hoon AHN, Daejeon (KR)

(21) Appl. No.: 18/849,905

(22) PCT Filed: Mar. 24, 2023
(86) PCT No.: PCT/KR2023/003982

§ 371 Date: Sep. 23, 2024

(30) Foreign Application Priority Data
Mar. 24, 2022 (KR) 10-2022-0036689

(51) Int. Cl. H01M 4/36; H01M 4/02; H01M 4/583; H01M 4/62; H01M 10/052

(52) U.S. Cl. CPC H01M 4/364; H01M 4/583; H01M 4/625; H01M 10/052; H01M 2004/021; H01M 2004/028

(57) ABSTRACT

A positive electrode for a lithium-sulfur battery, a positive electrode comprising the same, a lithium secondary battery comprising the positive electrode, and a method for preparing a positive electrode slurry are provided. The positive electrode comprises a positive electrode active material, a first conductive material and a second conductive material, wherein the positive electrode active material comprises a sulfur-carbon composite comprising a porous carbon material and sulfur (S), the first conductive material comprises fibers having an average particle size of 5 μm or less and the second conductive material comprises secondary particles including agglomerates of two or more primary particles of carbon nanotubes (CNT), and the combination of the conductive materials provides improved output characteristics and capacity of the lithium secondary battery.

### CROSS-REFERENCE TO RELATED APPLICATIONS

This application is a National Phase entry pursuant to 35 U.S.C. § 371 of International Application No. PCT/KR2023/003982 filed on Mar. 24, 2023 and claims priority to Korean Patent Application No. 10-2022-0036689 filed on Mar. 24, 2022, the disclosures of which are incorporated herein by reference in their entirety.

### FIELD

The present disclosure relates to a lithium-sulfur battery with improved battery performance such as output and capacity.

### BACKGROUND

A positive electrode of a lithium-sulfur battery may comprise a conductive material in an amount of 0 to 10 wt % based on 100 wt % of a positive electrode material to conduct electrons, and the commonly used conductive material includes activated carbon materials such as carbon black, denka black, ketjen black or carbon fibers or carbon nanotubes (CNT).

The CNT or carbon fibers are commonly used in a form of a pre-dispersion in which fiber stands are completely dispersed, or powder particles in which carbon fibers are entangled. However, there is no proposed technology to optimize the performance improvement of the conductive material by controlling the dispersion.

### SUMMARY

The present disclosure is directed to providing a new combination of conductive materials and their amounts for improving the output and capacity characteristics in a positive electrode for a lithium-sulfur battery. The present disclosure is further directed to providing a positive electrode for a lithium-sulfur battery comprising the new combination of conductive materials and a lithium ion secondary battery comprising the positive electrode.

A first aspect of the present disclosure relates to a positive electrode material composition of a lithium-sulfur battery, and the positive electrode material composition comprises a positive electrode active material, a conductive material, and a binder material, wherein the positive electrode active material comprises a sulfur-carbon composite comprising a porous carbon material and sulfur (S), the conductive material comprises a first conductive material and a second conductive material, the first conductive material comprises fibers having an average particle size of 5 μm or less, the second conductive material comprises secondary particles including agglomerates of two or more primary particles of carbon nanotubes (CNT), an average particle size of the second conductive material is 10 μm to 70 μm, and the positive electrode active material is included in a range between 80 wt % and 97 wt %, the conductive material is included in a range between 2 wt % and 10 wt %, and the binder material is included in a range between 2 wt % and 10 wt %.

According to a second aspect of the present disclosure, in the first aspect, the first conductive material comprises CNT, and an average number of walls of the CNT of the first conductive material is 1 to 20.

According to a third aspect of the present disclosure, in the second aspect, the first conductive material comprises the CNT, and the first conductive material is included in an amount of 0.1 wt % to 0.5 wt % based on a total weight of the positive electrode active material, the binder material, and the conductive material.

According to a fourth aspect of the present disclosure, in any one of the first to third aspects, the first conductive material comprises carbon fibers, and the carbon fibers have a diameter of 100 nm to 2 μm.

According to a fifth aspect of the present disclosure, in any one of the first to fourth aspects, an average number of walls of the CNT of the second conductive material is 1 to 20, and an average diameter of the primary particles of the CNT is 0.4 nm to 100 nm.

According to a sixth aspect of the present disclosure, in any one of the first to fifth aspects, the first conductive material is included in an amount of 0.1 wt % to 5 wt % and the second conductive material is included in an amount of 1 wt % to 5 wt % based on a total weight 100 wt % of the positive electrode active material, the binder material and the conductive material.

According to a seventh aspect of the present disclosure, in any one of the first to sixth aspects, the porous carbon material has a BET specific surface area of primary particles in a range between 100 m²/g and 3,000 m²/g.

According to an eighth aspect of the present disclosure, in any one of the first to seventh aspects, the porous carbon material comprises one or more selected from the group consisting of activated carbon, CNT, and graphene.

According to a ninth aspect of the present disclosure, in any one of the first to eighth aspects, the porous carbon material comprises CNT, and an average number of walls of the CNT of the porous carbon material is 1 to 20.

According to a tenth aspect of the present disclosure, in any one of the first to ninth aspects, the sulfur-carbon composite is included in an amount of 70 wt % or more based on 100 wt % of the positive electrode active material.

According to an eleventh aspect of the present disclosure, in any one of the first to tenth aspects, the sulfur is included in an amount of 70 wt % or more based on 100 wt % of the sulfur-carbon composite.

According to a twelfth aspect of the present disclosure, in any one of the first to eleventh aspects, the sulfur-carbon composite has one or more of a composite in which the sulfur and the carbon material are simply mixed, a coated core-shell structure, or a structure of the porous carbon material with sulfur loaded in pores thereof.

Meanwhile, a thirteenth aspect of the present disclosure relates to a positive electrode for an electrochemical device, and the positive electrode comprises the positive electrode material composition according to any one of the first to twelfth aspects.

Additionally, a fourteenth aspect of the present disclosure relates to a lithium secondary battery comprising the positive electrode for the electrochemical device.

Additionally, the present disclosure relates to a method for preparing a positive electrode slurry. A fifteenth aspect of the present disclosure relates to the method, and the method comprises mixing the positive electrode material composition according to any one of the first to twelfth aspects with a second solvent, wherein the first conductive material is added in a state where its average particle size is controlled to be 5 μm or less and wherein the second conductive material is added in powder state, wherein the second conductive material comprises secondary particles comprising agglomerates of two or more primary particles of CNT, and an average particle size of the second conductive material comprising the secondary particles is 10 μm to 70 μm.

According to a sixteenth aspect of the present disclosure, in the fifteenth aspect, the second solvent comprises one or more selected from water and an organic solvent.

According to a seventeenth aspect of the present disclosure, in the fifteenth or sixteenth aspect, when the first conductive material comprises CNT, the CNT of the first conductive material is fed into the slurry in a form of a mixed solution in which the CNT is mixed with a first solvent.

In lithium-sulfur secondary batteries, it may be possible to improve output characteristics and capacity by the new combination of conductive materials according to the present disclosure.

### BRIEF DESCRIPTION OF DRAWINGS

FIG. 1 shows output and capacity characteristics of batteries according to examples 1 and 2 of the present disclosure compared to comparative example 1.

FIG. 2 shows specific resistance measurement results of batteries according to comparative examples 1, 3 and 4.

FIG. 3 shows specific resistance measurement results of batteries according to comparative examples 1, 6, 7, and 8.

FIG. 4a shows discharge characteristics measurement results of batteries according to comparative examples 1 and 2.

FIG. 4b shows discharge characteristics measurement results of batteries according to comparative examples 1, 3, and 4.

FIG. 5 shows discharge characteristics measurement results of batteries according to comparative examples 1, 5, and 6.

FIG. 6 shows discharge characteristics measurement results of batteries according to comparative examples 1, 9, and 10.

FIG. 7 shows discharge characteristics results of batteries according to example 1 and comparative examples 1 and 11.

### DETAILED DESCRIPTION

Hereinafter, the present disclosure will be described in more detail.

It should be understood that the terms or words used in the specification and the appended claims should not be construed as limited to general and dictionary meanings, but rather interpreted based on the meanings and concepts corresponding to the technical aspect of the present disclosure on the basis of the principle that the inventor is allowed to define terms appropriately for the best explanation.

The term “comprise” or “include” when used in this specification, specifies the presence of stated elements, but does not preclude the presence or addition of one or more other elements, unless the context clearly indicates otherwise.

Additionally, the terms “about” and “substantially” as used herein are used in the sense of at, or nearly at, when given the manufacturing and material tolerances inherent in the stated circumstances, and are used to prevent the unscrupulous infringer from unfairly taking advantage of the present disclosure where exact or absolute figures are stated as an aid to understanding the present disclosure.

Throughout the specification, “A and/or B” refers to either A or B or both.

In the present disclosure, “specific surface area” is measured by the Brunauer, Emmett and Teller (BET) method, and specifically, it may be calculated from the adsorption amount of nitrogen gas under the liquid nitrogen temperature (77 K) using BEL Japan's BELSORP-mino II.

The term “polysulfide” as used herein is the concept that covers “polysulfide ion (Sx²⁻, X=8, 6, 4, 2)” and “lithium polysulfide (Li₂Sₓ or LiSₓ⁻, x=8, 6, 4, 2)”.

The term “composite” as used herein refers to a material with physically·chemically different phases and more effective functions, formed by combining two or more materials.

The term “porosity” as used herein refers to a fraction of voids in a structure over the total volume and is represented by %, and may be used interchangeably with void fraction, degree of porosity or the like.

In the present disclosure, “particle size D₅₀” refers to a particle size at 50% of cumulative volume particle size distribution of particles. The particle size D₅₀ may be measured using a laser diffraction method. For example, the particle size D₅₀ may be measured by dispersing the particles in a dispersion medium, introducing into commercially available laser diffraction particle size measurement machine (for example, Microtrac MT 3000), irradiating ultrasound of about 28 kHz with an output of 60 W to acquire a cumulative volume particle size distribution graph, and determining the particle size corresponding to 50% of the cumulative volume.

When used herein, “fiber thickness” refers to an average fiber thickness of a fibrous carbon material observed using scanning electron microscopy (SEM), and the fiber thickness may be estimated through the particle size at the location of the smallest peak among peaks observed on the particle size distribution measured by the laser diffraction method.

Additionally, each element in the drawings is arbitrarily depicted in arbitrary size and thickness for convenience of description, and the present disclosure is not necessarily limited thereto. In the drawings, thickness is exaggerated to clearly depict a plurality of layers and regions. Additionally, in the drawings, for convenience of description, the thickness of some layers and regions is exaggerated.

It should be further understood that “comprising” when used in this specification, specifies the presence of stated elements, but does not preclude the presence or addition of one or more other elements unless expressly stated otherwise.

The present disclosure relates to a positive electrode material composition for a lithium-sulfur battery. In an embodiment of the present disclosure, the positive electrode material composition comprises a positive electrode active material, a conductive material, and a binder material. In the positive electrode material composition, the positive electrode active material may be included in an amount of 80 wt % to 97 wt %, the conductive material may be included in an amount of 2 wt % to 10 wt %, and the binder may be included in an amount of 2 wt % to 10 wt % based on the total weight of the positive electrode active material, the conductive material, and the binder material. Meanwhile, the positive electrode material composition may further comprise a solvent if necessary, and the solvent may further comprise one or more of first and second solvents as described below.

Subsequently, each component will be described in more detail.

### Positive Electrode Active Material

The positive electrode active material according to the present disclosure comprises a sulfur-carbon composite. Preferably, the positive electrode active material may comprise the sulfur-carbon composite in an amount of 80 wt % or more, and preferably 90 wt % or more based on 100 wt % of the positive electrode active material, and more preferably the positive electrode active material may consist of the sulfur-carbon composite. Additionally, the sulfur content is preferably 70 wt % or more based on 100 wt % of the sulfur-carbon composite.

In an embodiment of the present disclosure, the sulfur-carbon composite may be a composite in which the sulfur and the carbon material are simply mixed or may have a coated or loaded core-shell structure. The coated core-shell structure may be a coating of one of the sulfur and the carbon material on the other, and for example, the carbon material surface may be covered with the sulfur or vice versa. Additionally, the loading type may be the sulfur-filled carbon material, in particular, sulfur filled in the pores of the carbon material. The sulfur-carbon composite may include any type of sulfur-carbon composite that satisfies the proposed ratio of amounts of the sulfur based compound and the carbon material and the present disclosure is not limited thereto. Meanwhile, in the present disclosure, the sulfur content is preferably 70 wt % or more based on the total weight of the positive electrode active material.

Since the sulfur is not electrically conductive itself, the sulfur is used in combination with the carbon material. For more details about the carbon material, reference is made to the following description. In an embodiment of the present disclosure, the sulfur may comprise one or more selected from the group consisting of inorganic sulfur (S₈), Li₂Sₙ (n>1), disulfide compounds such as 2,5-dimercapto-1,3,4-thiadiazole, 1,3,5-trithiocyanuic acid, organic sulfur compounds and carbon-sulfur polymer ((C₂Sₓ)ₙ, X=2.5 to 50, n>2). Preferably, the sulfur may comprise inorganic sulfur (S₈).

Among many secondary batteries, a lithium-sulfur battery is gaining attention as a next-generation secondary battery since it has high discharge capacity and theoretical energy density, sulfur used as a positive electrode active material is one of the abundant and low-cost elements, leading to lower manufacturing cost of the battery, and it offers eco-friendliness advantage.

In the lithium-sulfur battery, the positive electrode active material, sulfur, does not conduct electricity, and thus to improve the electrical conductivity, it is common to mix sulfur with a conductive material, for example, a carbon material into a sulfur-carbon composite.

The sulfur-carbon composite comprises the porous carbon material and sulfur. In an embodiment of the present disclosure, the sulfur-carbon composite may be a structure of the porous carbon material with the sulfur loaded in the pores thereof.

The carbon material has a porous structure comprising a plurality of non-uniform pores on the surface and inside, and acts as a host to provide skeleton for uniform and stable immobilization of sulfur, and increases low electrical conductivity of sulfur for smooth electrochemical reaction. In particular, in the sulfur-carbon composite, when the carbon material that acts as a sulfur host has a large BET specific surface area and a proper particle size (D₅₀), it may be possible to achieve high sulfur loading, low irreversible capacity and high energy density, thereby increasing sulfur availability in the electrochemical reaction.

In an embodiment of the present disclosure, the BET specific surface area of the carbon material may be a minimum of 100 m²/g and a maximum of 3000 m²/g. Along with this or independently of this, the carbon material may have the particle size (D₅₀) of primary particles in a range between 1 μm and 50 μm.

When the BET specific surface area and particle size (D₅₀) of the carbon material satisfy the above-described ranges, it may be possible to uniformly distribute sulfur over the inner and outer surface of the carbon material, and reduce the irreversible capacity, thereby increasing the electrochemical reactivity of sulfur. Additionally, the use of the carbon material improves the electrochemical reactivity, stability and electrical conductivity of the sulfur-carbon composite, thereby improving the capacity and life characteristics of the lithium-sulfur battery and ensuring the optimal charge/discharge performance despite sulfur loss or volume change during charging/discharging.

In case that the particle size (D₅₀) of primary particles is larger than 50 μm, lithium ions have difficulty in moving into the particles due to the limited movement of a material, which makes it difficult to efficiently use sulfur disposed at the center of carbon. In case that the particle size (D₅₀) of primary particles is smaller than 1 μm, it requires a large amount of solvents to prepare an electrode slurry, so it is difficult to increase a solid content, thereby failing to ensure adequate pores between particles, resulting in low output.

In the sulfur-carbon composite of the present disclosure, the carbon material used as a sulfur host may be, in general, manufactured by carbonizing precursors of various carbon materials.

Meanwhile, in an embodiment of the present disclosure, the pores of the carbon material may have the diameter in a range between 0.5 nm and 200 nm on the basis of the longest diameter. The shape of the carbon material may be spherical, rod-like, needle-like, platy, tubular or bulky, and may include, without limitation, any shape commonly used in lithium-sulfur secondary batteries.

The carbon material may comprise any carbon material having porous and conductive properties commonly used in the corresponding technical field. For example, the carbon material may comprise one or more selected from the group consisting of graphite; graphene; carbon black including denka black, acetylene black, ketjen black, channel black, furnace black, lamp black, thermal black; carbon nanotubes (CNT) including single-walled carbon nanotubes (SWCNT), multi-walled carbon nanotubes (MWCNT); carbon fibers including graphite nanofibers (GNF), carbon nanofibers (CNF), activated carbon fibers (ACF); graphite including natural graphite, artificial graphite, expandable graphite; carbon nanoribbon; carbon nanobelt, carbon nanorod and activated carbon.

In the sulfur-carbon composite according to the present disclosure, the sulfur may be disposed on at least one surface of the inner surface of the pores of the carbon material or the outer surface of the carbon material, and in this instance, the sulfur may be present in an area of less than 100% of the entire inner and outer surface of the carbon material, preferably 1% to 95%, and more preferably 60% to 90%. When the sulfur is present on the surface of the carbon material within the above-described range, it may be possible to obtain the maximum effect in terms of electron transport area and electrolyte wetting. Specifically, when the sulfur is impregnated over the surface of the carbon material uniformly to a small thickness at the area of the above-described range, it may be possible to increase the electron transport contact area during charging/discharging. In case that the sulfur is present in the area corresponding to 100% of the entire surface of the carbon material, the carbon material is completely covered with sulfur, resulting in poor electrolyte wetting and low contact with the conductive material included in the electrode, thereby failing to accept electrons and participate in reaction.

Additionally, in an embodiment of the present disclosure, the sulfur-carbon composite may be obtained by the following manufacturing method.

The method for manufacturing the sulfur-carbon composite according to the present disclosure is not limited to a particular one and may include any method commonly used in the corresponding technical field, and the sulfur-carbon composite may be manufactured by a composite manufacturing method including (S1) mixing the carbon material with sulfur, and (S2) forming a composite.

The step (S1) of mixing may be performed using a stirrer commonly used in the corresponding technical field to improve the mixing between the sulfur and the carbon material. In this instance, the mixing time and speed may be selectively adjusted according to the amounts of the raw materials and conditions.

The step (S2) of forming the composite is not limited to a particular method in the present disclosure and may use any method commonly used in the corresponding technical field. The method commonly used in the corresponding technical field may include, for example, a dry process or a wet process such as such as spray coating. For example, the mixture of the sulfur and the carbon material obtained by mixing may be thermally treated to uniformly coat the molten sulfur on the inner and outer surface of the carbon material. Meanwhile, in an embodiment of the present disclosure, before the thermal treatment, the mixture of the sulfur and the carbon material may be milled by ball milling. In an embodiment of the present disclosure, the thermal treatment may be performed in the temperature condition of 120° C. to 160° C. for about 20 minutes to 24 hours, and a heater such as an oven may be used.

Since the sulfur-carbon composite manufactured through the above-described manufacturing method has large specific surface area, high sulfur loading and improved availability of sulfur, it may be possible to improve the electrochemical reactivity of sulfur and improve the accessibility and contact of the electrolyte solution, thereby improving the capacity and life characteristics of the lithium-sulfur battery.

### Conductive Material

The positive electrode material composition according to the present disclosure comprises the conductive material, and the conductive material comprises a first conductive material and a second conductive material.

The first conductive material is fibrous or needle-like, and has an average particle size of 5 μm or less according to particle size distribution (PSD) analysis. The PSD may be measured using a particle size distribution analyzer. For example, the PSD may be calculated by putting the first conductive material into commercially available laser PSD particle size measurement machine (for example, Microtrac S3500) and measuring a diffraction pattern difference according to the particle size when particles pass through a laser beam.

In an embodiment of the present disclosure, the average particle size may be a value determined by dry or wet analysis for PSD analysis. For example, the dry analysis is a method of analyzing the particle size of particles dispersed in air, and the wet analysis is a method of analyzing the particle size of particles dispersed in a solvent (for example, water). Meanwhile, the average particle size of the first conductive material may be maintained in the positive electrode material composition, a positive electrode slurry and a positive electrode obtained therefrom.

The first conductive material may comprise one or more selected from the group consisting of carbon nanotubes and carbon fibers. In an embodiment of the present disclosure, the carbon fibers may have a fiber diameter of 100 nm to 2 μm. The average number of walls of the carbon nanotubes may be 1 to 20, and the average diameter (diameter) of primary particles (a strand of carbon nanotube) of the carbon nanotubes may be 0.4 nm to 100 nm. Here, the diameter of the carbon fibers and the diameter of primary particles of the carbon nanotubes may be measured using Transmission Electron Microscope (TEM) or Scanning Electron Microscope (SEM).

The average diameter of primary particles of the carbon nanotubes may be calculated by averaging the diameters of primary particles in an image of the carbon nanotubes observed by TEM or SEM. In this instance, the number of primary particles observed may be, for example, 10 to 50, but is not limited thereto.

The carbon fibers which have a diameter of 100 nm to 2 μm may represent that the diameter of carbon fibers randomly selected in an image of the carbon fibers observed by TEM or SEM is in the above-described range. For example, when an image of carbon fibers are captured by TEM and the measured diameters of 10 to 50 carbon fibers randomly selected in the image are all 100 nm to 2 μm, the carbon fibers may have the diameter of 100 nm to 2 μm. However, the number of carbon fibers selected in the diameter measurement is not limited to 10 to 50.

When the first conductive material comprises one or more selected from the group consisting of carbon nanotubes and carbon fibers as described above, the battery comprising the positive electrode material composition comprising the same may have low specific resistance and improved capacity.

Meanwhile, when the first conductive material comprises CNT, the CNT is preferably included in an amount of 0.1 to 0.5 wt % based on the total weight of the positive electrode active material, the binder material, and the conductive material. In case that the amount of the CNT is below the above-described range, the connection effect of conduction pathways is low, thereby failing to improve the output, and in case that the amount of the CNT is above the above-described range, the CNT forms a film, resulting in clogged pores and poor battery reaction, thereby reducing the output.

Meanwhile, when the first conductive material comprises carbon fibers, the carbon fibers are preferably included in an amount of 1 to 10 wt % based on the total weight 100 wt % of the positive electrode active material, the binder material and the conductive material. In case that the amount of the carbon fibers is below the above-described range, the connection effect of conduction pathways is low, thereby failing to improve the output, and in case that the amount of the carbon fibers is above the above-described range, the carbon fibers form a film, resulting in clogged pores and poor battery reaction, thereby reducing the output.

Meanwhile, in an embodiment of the present disclosure, to maintain the average particle size of 5 μm or less and improve dispersion in the positive electrode material composition, the first conductive material may be dispersed in a first solvent, for example, water or a suitable organic solvent (NMP, acetone) to prepare a mixed solution and the mixed solution may be fed into the positive electrode material composition. In particular, the CNT exists as non-dispersible secondary particles when synthesized by vapor synthesis, and even though dispersion is carried out, when its extent is not adequate, the CNT agglomerates into secondary particles having the average particle size of more than 5 μm. When the above-described mixed solution is prepared, the average particle size of the CNT may be controlled to 5 μm or less. Meanwhile, when the first conductive material comprises carbon fibers, the carbon fibers may be adequately dispersed without being first dispersed in a solvent when preparing the mixed solution (slurry) of the positive electrode composition and may have the average particle size of 5 μm or less. Accordingly, the first conductive material is not necessarily added in the form of the mixed solution.

Meanwhile, in an embodiment of the present disclosure, the second conductive material has an average particle size of 10 μm to 70 μm according to the PSD measurement results. The second conductive material may comprise CNT. The average number of walls of the CNT of the second conductive material may be 1 to 20, and the average diameter of primary particles may be 0.4 nm to 100 nm. The second conductive material has the average particle size of 10 μm to 70 μm, and comprises secondary particles formed by agglomeration of two or more primary particles. The second conductive material comprising secondary particles of the above-described average particle size is fed into the positive electrode material composition and maintains the average particle size in the positive electrode material composition, and as opposed to the first conductive material, it is better not to apply the process of preparing the mixed solution and pre-dispersing before adding to the positive electrode material composition.

Meanwhile, in a specific embodiment of the present disclosure, the first conductive material may be included in an amount of 0.1 wt % to 5 wt % and the second conductive material may be included in an amount of 1 wt % to 5 wt % based on the total weight 100 wt % of the positive electrode active material, the binder material and the conductive material.

### Binder Material

The binder material may play a role in attaching the positive electrode active material particles to each other and improving the adhesion strength between the positive electrode active material and the positive electrode current collector, and specific examples may include one or more of polyvinylidenefluoride (PVDF), a vinylidene fluoride-hexafluoropropylene copolymer (PVDF-co-HFP), polyvinylalcohol, polyacrylonitrile, carboxymethyl cellulose (CMC), starch, hydroxypropylcellulose, regenerated cellulose, polyvinylpyrrolidone, polytetrafluoroethylene, polyethylene, polypropylene, ethylene-propylene-diene monomer rubber (EPDM rubber), sulfonated-EPDM, styrene butadiene rubber (SBR), fluoro rubber, or a variety of copolymers thereof.

### Other Positive Electrode Materials

In an embodiment of the present disclosure, the positive electrode active material may consist of the sulfur-carbon composite. Meanwhile, in an embodiment of the present disclosure, in addition to the sulfur-carbon composite, the positive electrode active material may further comprise one or more additives selected from transition metal elements, Group IIIA elements, Group IVA elements, sulfur compounds of these elements and alloys of these elements and sulfur.

In a specific embodiment of the present disclosure, the positive electrode active material layer may further comprise lithium transition metal composite oxide represented by the following [Chemical formula 1].

LiₐNi_{b}Co_{c}M¹_{d}M²ₑO₂ [Chemical formula 1]

In the above Chemical formula 1, M¹ may be Mn, Al or a combination thereof, and preferably Mn, or Mn and Al.

The M² may be one or more selected from the group consisting of Zr, W, Y, Ba, Ca, Ti, Mg, Ta and Nb, preferably one or more selected from the group consisting of Zr, Y, Mg, and Ti, and more preferably Zr, Y or a combination thereof. The M² is optional, but when it is included in an optimal amount, it may play a role in promoting the particle growth during sintering and improving the crystal structure stability.

Meanwhile, a positive electrode slurry and a positive electrode may be manufactured using the positive electrode material composition as below.

The positive electrode slurry may be prepared by mixing the above-described positive electrode material composition with a second solvent. The solid content in the positive electrode slurry may be in a range between 20 wt % and 50 wt %. The solids in the positive electrode slurry do not comprise the second solvent, and when the first conductive material is pre-dispersed in a form of a mixed solution and the mixed solution is fed, the solids refer to the remaining substances except not only the second solvent but also the first solvent of the pre-dispersed solution.

The first conductive material having the controlled average particle size of 5 μm or less is fed into the slurry. Meanwhile, the second conductive material is fed in a powder state comprising CNT secondary particles, and the average particle size of the secondary particles is 10 μm to 70 μm.

In an embodiment of the present disclosure, the second solvent may comprise one or more selected from water and an organic solvent (NMP or acetone).

Meanwhile, as described above, when the first conductive material comprises CNT, the CNT may be mixed with the first solvent and pre-dispersed such that the average particle size is 5 μm or less, and the resulting mixed solvent may be fed into the slurry.

When the positive electrode slurry is prepared as described above, the positive electrode slurry may be coated on at least one surface of a metal foil for the positive electrode current collector and dried to manufacture the positive electrode. In the manufacture of the positive electrode, the process details about slurry coating, drying, thickness and porosity control by applying pressure may follow the known technology in the technical field pertaining to the present disclosure.

For example, the second solvent may be prepared and the above-described positive electrode material composition may be added to prepare the positive electrode slurry. Meanwhile, in an embodiment of the present disclosure, among the positive electrode material composition, the binder material may be first added to the second solvent to prepare a binder solution, and subsequently, the remaining materials may be added. The second solvent for preparing the positive electrode slurry may preferably include solvents that may uniformly disperse the positive electrode material composition and easily evaporate. Typically, acetonitrile, methanol, ethanol, tetrahydrofuran, water and isopropylalcohol may be used.

The prepared slurry is coated on the current collector and dried to form the positive electrode. The slurry may be coated on the current collector to a proper thickness according to the viscosity of the slurry and desired thickness of the positive electrode.

The coating may be performed by methods commonly used in the corresponding technical field, and for example, may be performed by applying the positive electrode active material slurry over an upper surface of the positive electrode current collector and uniformly spreading using a doctor blade. Besides, the coating may be performed by die casting, comma coating, screen printing or the like.

The drying is not limited to a particular condition, but may be performed under the temperature of 50° C. to 200° C. within 1 day. The drying may be performed, for example, using an oven, and may be performed in a vacuum condition.

Another aspect of the present disclosure relates to the positive electrode comprising the sulfur-carbon composite. The positive electrode comprises the positive electrode current collector; and the positive electrode active material layer on at least one surface of the positive electrode current collector, wherein the positive electrode active material layer comprises the positive electrode active material, the conductive material and the binder material. The positive electrode active material layer is derived from the above-described positive electrode material composition, and for more details about the positive electrode components, reference is made to the foregoing description. Meanwhile, in an embodiment of the present disclosure, as described above, the positive electrode active material layer may comprise the positive electrode active material, the conductive material and the binder material, and the positive electrode active material may be included in an amount of 80 wt % to 97 wt %, the conductive material may be included in an amount of 2 wt % to 10 wt %, and the binder may be included in an amount of 2 wt % to 10 wt % based on the total weight of the positive electrode active material, the conductive material and the binder material. Additionally, the sulfur-carbon composite may be included in an amount of 70 wt % or more based on the total weight of the positive electrode active material, and the sulfur content may be 70 wt % or more based on the total weight of the sulfur-carbon composite. In a specific embodiment of the present disclosure, the sulfur content is preferably 70 wt % or more based on the total weight of the positive electrode active material.

Meanwhile, the positive electrode current collector may include various types of positive electrode current collectors used in the corresponding technical field. For example, the positive electrode current collector may include stainless steel, aluminum, nickel, titanium, sintered carbon or aluminum or stainless steel treated with carbon, nickel, titanium or silver on the surface. The positive electrode current collector may be typically 3 μm to 500 μm in thickness, and the positive electrode current collector may have microtexture on the surface to increase the adhesion strength of the positive electrode active material. The positive electrode current collector may come in various forms, for example, a film, a sheet, a foil, a net, a porous body, a foam and a nonwoven.

Additionally, the present disclosure provides a lithium-sulfur battery comprising an electrode assembly comprising a positive electrode comprising the above-described sulfur-carbon composite and an electrolyte solution. The electrode assembly comprises a positive electrode, a negative electrode, and a separator between the positive electrode and the negative electrode.

For example, the electrode assembly may form a stack type or stack/folding structure including the negative electrode and the positive electrode stacked with the separator between the negative electrode and the positive electrode, or a jelly-roll structure including the negative and positive electrodes wound with the separator disposed between. Furthermore, in the jelly-roll structure, an additional separator may be placed on the outer side to prevent the contact between the negative electrode and the positive electrode.

The negative electrode comprises a negative electrode current collector; and a negative electrode active material layer on at least one surface of the negative electrode current collector, and the negative electrode active material layer comprises a negative electrode active material, a conductive material, and a binder.

Subsequently, the negative electrode will be described in more detail.

The negative electrode may comprise a long sheet shaped negative electrode current collector and a negative electrode active material layer on one or two surfaces of the negative electrode current collector, and the negative electrode active material layer may comprise the negative electrode active material, the conductive material, and the binder.

Specifically, the negative electrode may be manufactured by coating a negative electrode slurry prepared by dispersing the negative electrode active material, the conductive material and the binder in a solvent such as dimethyl sulfoxide (DMSO), isopropyl alcohol, N-methylpyrrolidone (NMP), acetone and water on one or two surfaces of the long sheet shaped negative electrode current collector, and removing the solvent from the negative electrode slurry through a drying process, and rolling. Meanwhile, the negative electrode comprising an uncoated portion may be manufactured by not coating the negative electrode slurry at part of the negative electrode current collector, for example, an end of the negative electrode current collector when coating the negative electrode slurry.

The negative electrode active material may include a material capable of reversible intercalation or deintercalation of lithium (Li⁺), a material capable of reversibly forming a lithium containing compound by reaction with lithium ions, a lithium metal and a lithium alloy.

In an embodiment of the present disclosure, when a lithium metal and/or a lithium alloy is used as the negative electrode active material, a metal foil made of these metal materials may be used as the negative electrode, and in this case, the current collector may not be included. The thin film type negative electrode may be 30 μm to 200 μm thick. Meanwhile, in an embodiment of the present disclosure, the negative electrode may be manufactured by laminating a reinforcing material of 100 μm or less on the metal foil or inserting the reinforcing material into the metal foil. The reinforcing material may be porous. Meanwhile, the reinforcing material may be conductive or non-conductive.

The material capable of reversible intercalation or deintercalation of lithium ions may include, for example, crystalline carbon, amorphous carbon or a mixture thereof, and specifically, may include artificial graphite, natural graphite, graphitizable carbon fibers, amorphous carbon, soft carbon and hard carbon, but is not limited thereto. The material capable of reversibly forming the lithium containing compound by reaction with the lithium ions may be, for example, tin oxide, titanium nitrate or a silicon-based compound. The lithium alloy may be, for example, an alloy of lithium (Li) and a metal selected from the group consisting of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al) and tin (Sn). Preferably, the negative electrode active material may be a lithium metal, and specifically, may be in a form of a lithium metal foil or a lithium metal powder. The silicon-based negative electrode active material may be Si, a Si—Me alloy (where Me is one or more selected from the group consisting of Al, Sn, Mg, Cu, Fe, Pb, Zn, Mn, Cr, Ti, and Ni), SiO_{y} (where 0<y<2), a Si—C composite or a combination thereof, and preferably SiO_{y} (where 0<y<2). Since the silicon-based negative electrode active material has high theoretical capacity, when the silicon-based negative electrode active material is included, it may be possible to improve capacity characteristics.

The negative electrode current collector may include negative electrode current collectors commonly used in the corresponding technical field, and may include, for example, copper, stainless steel, aluminum, nickel, titanium, sintered carbon, copper or stainless steel treated with carbon, nickel, titanium or silver on the surface, and an aluminum-cadmium alloy. The negative electrode current collector may be typically 3 to 500 μm in thickness, and in the same way as the positive electrode current collector, may have microtexture on the surface to enhance the bonding strength of the negative electrode active material. For example, the negative electrode current collector may come in various forms, for example, a film, a sheet, a foil, a net, a porous body, a foam and a nonwoven.

The conductive material may be used to provide conductive properties to the negative electrode, and may include, without limitation, any conductive material having the ability to conduct electrons without causing any chemical change in the corresponding battery. Specific examples may include one or more of graphite such as natural graphite or artificial graphite; a carbon-based material such as carbon black, acetylene black, ketjen black, channel black, furnace black, lamp black, thermal black, carbon fibers, carbon nanotubes; metal powder or metal fibers of copper, nickel, aluminum, silver; conductive whiskers of zinc oxide, potassium titanate; conductive metal oxide such as titanium oxide; or conductive polymer such as polyphenylene derivatives. The conductive material may be typically included in an amount of 1 wt % to 30 wt %, preferably 1 wt % to 20 wt %, and more preferably 1 to 10 wt % based on the total weight of the negative electrode active material layer.

The binder may play a role in attaching the negative electrode active material particles to each other and improving the adhesion strength between the negative electrode active material and the negative electrode current collector. Specific examples may include one or more of polyvinylidene fluoride (PVDF), a vinylidene fluoride-hexafluoropropylene copolymer (PVDF-co-HFP), polyvinylalcohol, polyacrylonitrile, carboxymethylcellulose (CMC), starch, hydroxypropylcellulose, regenerated cellulose, polyvinylpyrrolidone, polytetrafluoroethylene, polyethylene, polypropylene, ethylene-propylene-diene monomer rubber (EPDM rubber), sulfonated-EPDM, styrene-butadiene rubber (SBR), fluoro rubber, or a variety of copolymers thereof. The binder may be included in an amount of 1 wt % to 30 wt %, preferably 1 wt % to 20 wt %, and more preferably 1 wt % to 10 wt % based on the total weight of the negative electrode active material layer.

Meanwhile, the electrode assembly further comprises the separator, and the separator is disposed between the negative electrode and the positive electrode in the electrode assembly. The separator may separate the negative electrode from the positive electrode and provide movement channels of lithium ions, and may include, without limitation, any type of separator commonly used in lithium secondary batteries. Specifically, the separator may include a porous polymer film, for example, a porous polymer film made of a polyolefin-based polymer such as an ethylene homopolymer, a propylene homopolymer, an ethylene/butene copolymer, an ethylene/hexene copolymer and an ethylene/methacrylate copolymer or a stack structure of two or more of them. Additionally, commonly used porous nonwoven fabrics, for example, nonwoven fabrics made of high melting point glass fibers, polyethyleneterephthalate fibers may be used. Additionally, coated separators comprising ceramics or polymer may be used to ensure heat resistance or mechanical strength.

Another aspect of the present disclosure relates to an electrochemical device comprising the electrode assembly. The electrochemical device may comprise a battery case accommodating the electrode assembly and the electrolyte solution, and the battery case may include, without limitation, any appropriate type of battery case commonly used in the corresponding technical field, for example, a pouch type or a metal can type.

The electrolyte used in the present disclosure may include any type of electrolyte available in lithium secondary batteries, for example, an organic liquid electrolyte, an inorganic liquid electrolyte, a solid polymer electrolyte, a gel polymer electrolyte, a solid inorganic electrolyte and a molten inorganic electrolyte, but is not limited thereto.

Specifically, the electrolyte may comprise an organic solvent and a lithium salt.

The organic solvent may include, without limitation, any type of organic solvent that may act as a medium for the movement of ions involved in the electrochemical reaction of the battery. Specifically, the organic solvent may include an ester-based solvent such as methyl acetate, ethyl acetate, γ-butyrolactone, ε-caprolactone; an ether-based solvent such as dibutyl ether or tetrahydrofuran; a ketone-based solvent such as cyclohexanone; an aromatic hydrocarbon-based solvent such as benzene, fluorobenzene; a carbonate-based solvent such as dimethylcarbonate (DMC), diethylcarbonate (DEC), methylethylcarbonate (MEC), ethylmethylcarbonate (EMC), ethylene carbonate (EC), propylene carbonate (PC); an alcohol-based solvent such as ethylalcohol, isopropyl alcohol; nitriles of R—CN (R is C2-C20 straight-chain, branched-chain or cyclic hydrocarbon, and may comprise an exocyclic double bond or ether bond); amides such as dimethylformamide; dioxolanes such as 1,3-dioxolane; or sulfolanes.

Meanwhile, in an embodiment of the present disclosure, a nonaqueous solvent of the electrolyte solution preferably comprises an ether-based solvent to improve the charge/discharge performance of the battery. As the nonaqueous solvent, the ether-based solvent may include one or more of linear ether (for example, methoxyethane, ethoxyethane, 1,2-dimethyoxyethane, dimethoxymethane, dimethoxyethane), cyclic ether (for example, 1,3-dioxolane or tetrahydrofuran, tetrohydropyran, etc.), a linear ether compound (for example, 1,2 dimethoxyethane, etc.) or low viscosity fluorinated ether (for example, 1H,1H,2′H,3H-decafluorodipropyl ether, difluoromethyl 2,2,2-trifluoroethyl ether, 1,2,2,2-tetrafluoroethyl trifluoromethyl ether, 1,1,2,3,3,3-hexafluoropropyl difluoromethyl ether, 1H,1H,2′H,3H-decafluorodipropyl ether, pentafluoroethyl 2,2,2-trifluoroethyl ether, 1H, 1H,2′H-perfluorodipropyl ether).

The lithium salt may include, without limitation, any compound that provides lithium ions used in lithium secondary batteries. Specifically, the lithium salt may include LiPF₆, LiClO₄, LiAsF₆, LiBF₄, LiSbF₆, LiAl0₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, LiB(C₂O₄)₂, lithium bis (trifluoromethanesulfonyl)imide (LiTFSI), or lithium bis(fluorosulfonyl)imide (LiFSI). The concentration of the lithium salt may be in a range between 0.1M and 5.0M, and preferably 0.1M and 3.0M. When the concentration of the lithium salt is included in the above-described range, the electrolyte may have proper conductivity and viscosity and exhibit the outstanding electrolyte performance, thereby effectively transporting lithium ions.

In addition to the above-described constituent substances of the electrolyte, the electrolyte may further comprise an additive to improve the life characteristics of the battery, prevent the capacity fading of the battery and improve the discharge capacity of the battery.

For example, the additive may include one or more of a haloalkylene carbonate-based compound such as difluoro ethylene carbonate, pyridine, triethylphosphite, triethanolamine, cyclic ether, ethylene diamine, n-glyme, hexamethylphosphoric triamide, nitrobenzene derivatives, sulfur, a quinone imine dye, N-substituted oxazolidinone, N,N-substituted imidazolidine, ethylene glycol dialkyl ether, an ammonium salt, pyrrole, 2-methoxy ethanol or aluminum trichloride, but is not limited thereto. The additive may be included in an amount of 0.1 wt % to 10 wt %, and preferably 0.1 wt % to 5 wt % based on the total weight of the electrolyte.

The lithium-sulfur battery is not limited to a particular shape and may come in various shapes, for example, cylindrical, stack and coin shapes.

Additionally, the present disclosure provides a battery module including the lithium-sulfur battery as a unit battery. The battery module may be used as a source of power for medium- and large-scale devices requiring high temperature stability, long cycling characteristics and high capacity characteristics.

Examples of the medium- and large-scale device may include power tools; electric cars including electric vehicles (EV), hybrid electric vehicles (HEV), plug-in hybrid electric vehicles (PHEV); electric two-wheeled vehicles including E-bikes, E-scooters; electric golf carts; energy storage systems that work using power produced by an electric motor, but is not limited thereto.

Hereinafter, examples are presented to help understanding of the present disclosure, but the following examples are provided to describe the present disclosure by way of example and it is obvious to those skilled in the art that various modifications and changes may be made without departing from the scope and technical aspect of the present disclosure, and such modifications and changes fall within the scope of the appended claims.

### Preparation Example

### Manufacture of Sulfur-Carbon Composite

CNT (average number of walls is 6) particles and sulfur were uniformly mixed and placed in an oven of 155° C. for 30 minutes to manufacture a sulfur-carbon composite. The sulfur content was 75 wt % based on 100 wt % of the sulfur-carbon composite.

### Manufacture of Positive Electrode

### Example 1

The sulfur-carbon composite as manufactured above, vapor grown carbon fiber (VGCF) as a first conductive material, CNT particles (average number of walls is 9) as a second conductive material, and poly acrylic acid (PAA) as a binder were added to water at a weight ratio of 92.0:2.5:2.5:3.0 to prepare a positive electrode slurry. The solid concentration in the slurry was 25 wt %. The average particle size of the VGCF was 5 μm. The second conductive material, CNT, comprises agglomerates of particles, the average particle size was 35 μm, and the CNT in powder state was fed into the positive electrode slurry. The slurry was coated on two surfaces of a 20 μm thick aluminum current collector such that the prepared positive electrode slurry composition is 250 μm thick, dried at 50° C. for 12 hours and pressed using a roll press to manufacture a positive electrode having the total thickness of 200 μm.

### Example 2

The sulfur-carbon composite as manufactured above, CNT (average number of walls is 2) as a first conductive material, CNT (average number of walls is 9) as a second conductive material, and poly acrylic acid (PAA) as a binder were added to water at a weight ratio of 94.3:0.2:2.5:3.0 to prepare a positive electrode slurry. The solid concentration in the slurry was 25 wt %. The first conductive material, CNT, was fed into the slurry in a form of a mixed solution in which the CNT is dispersed in water. A weight ratio of water: the CNT: dispersant in the mixed solution was 99:0.3:0.7. Additionally, the average particle size of the CNT in the mixed solution was 1 μm. The second conductive material, another CNT, comprising agglomerates of particles and having an average particle size of 35 μm was fed in powder state into the positive electrode slurry. The slurry was coated on two surfaces of a 20 μm thick aluminum current collector such that the prepared positive electrode slurry composition was 250 μm thick, dried at 50° C. for 12 hours and pressed using a roll press to manufacture a positive having the thickness of 200 μm.

### Comparative Example 1

The sulfur-carbon composite as manufactured above and poly acrylic acid (PAA) as a binder were added to water at a weight ratio of 97:3 to prepare a positive electrode slurry. The solid concentration in the slurry was 25 wt %. The slurry was coated on two surfaces of a 20 μm thick aluminum current collector such that the prepared positive electrode slurry composition was 250 μm thick, dried at 50° C. for 12 hours and pressed using a roll press to manufacture a positive electrode having the thickness of 200 μm.

### Comparative Example 2

The sulfur-carbon composite as manufactured above, VGCF as a conductive material and poly acrylic acid (PAA) as a binder were added to water at a weight ratio of 94.5:2.5:3.0to prepare a positive electrode slurry. The solid concentration in the slurry was 25 wt %. The average particle size of the VGCF was 5 μm. The slurry was coated on two surfaces of a 20μm thick aluminum current collector such that the prepared positive electrode slurry composition was 250 μm thick, dried at 50° C. for 12 hours and pressed using a roll press to manufacture a positive electrode having the thickness of 200 μm.

### Comparative Example 3

The sulfur-carbon composite as manufactured above, VGCF as a conductive material and poly acrylic acid (PAA) as a binder were added to water at a weight ratio of 92.0:5.0:3.0 to prepare a positive electrode slurry. The solid concentration in the slurry was 25 wt %. The average particle size of the VGCF was 5 μm. The slurry was coated on two surfaces of a 20μm thick aluminum current collector such that the prepared positive electrode slurry composition was 250 μm thick, dried at 50° C. for 12 hours and pressed using a roll press to manufacture a positive electrode having the thickness of 200 μm.

### Comparative Example 4

The sulfur-carbon composite as manufactured above, VGCF as a conductive material and poly acrylic acid (PAA) as a binder were added to water at a weight ratio of 87.0:10.0:3.0to prepare a positive electrode slurry. The solid concentration in the slurry was 25 wt %. The average particle size of the VGCF was 5 μm. The slurry was coated on two surfaces of a 20 μm thick aluminum current collector such that the prepared positive electrode slurry composition was 250 μm thick, dried at 50° C. for 12 hours and pressed using a roll press to manufacture a positive electrode having the thickness of 200 μm.

### Comparative Example 5

The sulfur-carbon composite as manufactured above, CNT (average number of walls is 2) as a conductive material and poly acrylic acid (PAA) as a binder were added to water at a weight ratio of 96.75:0.25:3.0 to prepare a positive electrode slurry. The solid concentration in the slurry was 25 wt %. The CNT was fed into the slurry in a form of a mixed solution in which the CNT is dispersed in water. A weight ratio of water:CNT:dispersant in the mixed solution was 99:0.3:0.7. Additionally, the average particle size of the CNT in the mixed solution was about 1 μm. The slurry was coated on a 20 μm thick aluminum current collector such that the prepared positive electrode slurry composition was 350 μm thick, dried at 50° C. for 12 hours and pressed using a roll press to manufacture a positive electrode having the thickness of 200 μm.

### Comparative Example 6

The sulfur-carbon composite as manufactured above, CNT (average number of walls is 2) as a conductive material and poly acrylic acid (PAA) as a binder were added to water at a weight ratio of 96.5:0.5:3.0 to prepare a positive electrode slurry. The solid concentration in the slurry was 25 wt %. The CNT was fed into the slurry in a form of a mixed solution in which the CNT is dispersed in water. A weight ratio of water: CNT: dispersant in the mixed solution was 99:0.3:0.7. Additionally, the average particle size of the CNT in the mixed solution was about 1 μm. The slurry was coated on a 20 μm thick aluminum current collector such that the prepared positive electrode slurry composition was 350 μm thick, dried at 50° C. for 12 hours and pressed using a roll press to manufacture a positive electrode having the thickness of 200 μm.

### Comparative Example 7

The sulfur-carbon composite as manufactured above, CNT (average number of walls is 2) as a conductive material and poly acrylic acid (PAA) as a binder were added to water at a weight ratio of 96.0:1.0:3.0 to prepare a positive electrode slurry. The solid concentration in the slurry was 25 wt %. The CNT was fed into the slurry in a form of a mixed solution in which the CNT is dispersed in water. A weight ratio of water:CNT:dispersant in the mixed solution was 99:0.3:0.7. Additionally, the average particle size of the CNT in the mixed solution was about 1 μm. The slurry was coated on a 20 μm thick aluminum current collector such that the prepared positive electrode slurry composition was 350 μm thick, dried at 50° C. for 12 hours and pressed using a roll press to manufacture a positive electrode having the thickness of 200 μm.

### Comparative Example 8

The sulfur-carbon composite as manufactured above, CNT (average number of walls is 2) as a conductive material and poly acrylic acid (PAA) as a binder were added to water at a weight ratio of 94.0:3.0:3.0 to prepare a positive electrode slurry. The solid concentration in the slurry was 25 wt %. The CNT was fed into the slurry in a form of a mixed solution in which the CNT is dispersed in water. A weight ratio of water:CNT:dispersant in the mixed solution was 99:0.3:0.7. Additionally, the average particle size of the CNT in the mixed solution was about 1 μm. The slurry was coated on a 20 μm thick aluminum current collector such that the prepared positive electrode slurry composition was 350 μm thick, dried at 50° C. for 12 hours and pressed using a roll press to manufacture a positive electrode having the thickness of 200 μm.

### Comparative Example 9

The sulfur-carbon composite as manufactured above, CNT (average number of walls is 9) as a conductive material and poly acrylic acid (PAA) as a binder were added to water at a weight ratio of 94.5:2.5:3.0 to prepare a positive electrode slurry. The solid concentration in the slurry was 25 wt %. The CNT comprises agglomerates of particles, the average particle size was 35 μm and the CNT in powder state was fed into the positive electrode slurry. The slurry was coated on two surfaces of a 20 μm thick aluminum current collector such that the prepared positive electrode slurry composition was 250 μm thick, dried at 50° C. for 12 hours and pressed using a roll press to manufacture a positive electrode having the thickness of 200 μm.

### Comparative Example 10

The sulfur-carbon composite as manufactured above, CNT (average number of walls is 9) as a conductive material and poly acrylic acid (PAA) as a binder were added to water at a weight ratio of 92.0:5.0:3.0 to prepare a positive electrode slurry. The solid concentration in the slurry was 25 wt %. The CNT comprises agglomerates of particles, the average particle size was 35 μm and the CNT in powder state was fed into the positive electrode slurry. The slurry was coated on two surfaces of a 20 μm thick aluminum current collector such that the prepared positive electrode slurry composition was 250 μm thick, dried at 50° C. for 12 hours and pressed using a roll press to manufacture a positive electrode having the thickness of 200 μm.

### Comparative Example 11

The sulfur-carbon composite as manufactured above, VGCF as a first conductive material, ketjen black as a second conductive material and poly acrylic acid (PAA) as a binder were added to water at a weight ratio of 92.0:2.5:2.5:3.0 to prepare a positive electrode slurry. The solid concentration in the slurry was 25 wt %. The average particle size of the VGCF was 5 μm. The second conductive material, ketjen black, comprises agglomerates of particles, the average particle size was 35 μm and the ketjen black in powder state was fed into the positive electrode slurry. The slurry was coated on two surfaces of a 20 μm thick aluminum current collector such that the prepared positive electrode slurry composition was 250 μm thick, dried at 50° C. for 12 hours and pressed using a roll press to manufacture a positive electrode having the total thickness of 200 μm.

### Manufacture of Battery

In manufacturing a battery, together with the positive electrode described above, a 35μm thick lithium metal foil was used as a negative electrode, and a mixed solution in which 0.6M lithium bis(trifluoromethanesulfonyl)imide (LiTFSI) and 3 wt % of lithium nitrate (LiNO3) was dissolved in a mixed organic solvent of 2-methyl furan and dimethoxyethane at a 33:77 volume ratio was used as an electrolyte.

Specifically, the positive electrode and the negative electrode were placed with an polyethylene separator having the thickness of 20 μm and porosity of 45% disposed therebetween, and the electrolyte was injected to manufacture a lithium-sulfur battery. The battery comprises a stack of seven sheets of positive electrodes and seven sheets of negative electrodes.

### Evaluation

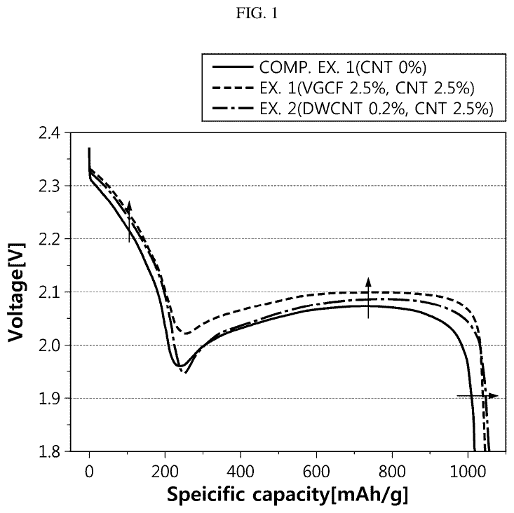

Referring to FIG. 1, it was confirmed that when the first and second conductive materials according to the present disclosure were used as in examples 1 and 2, both the output and capacity at the start/end of discharge were improved.

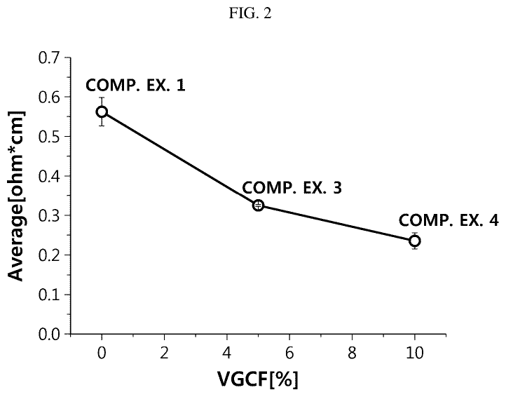

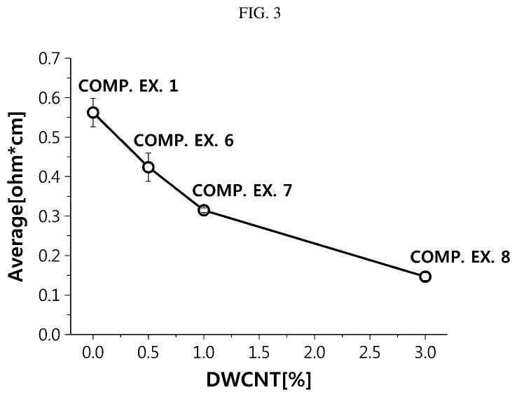

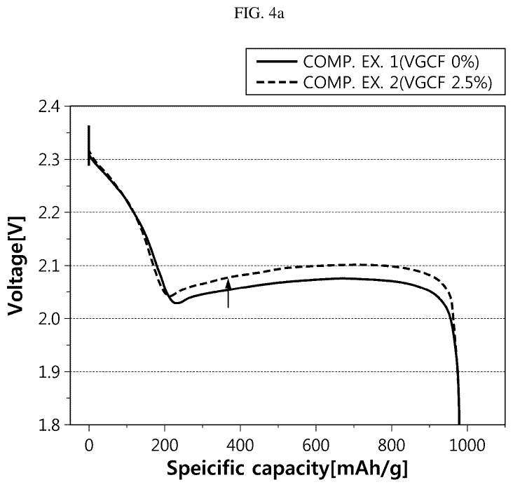

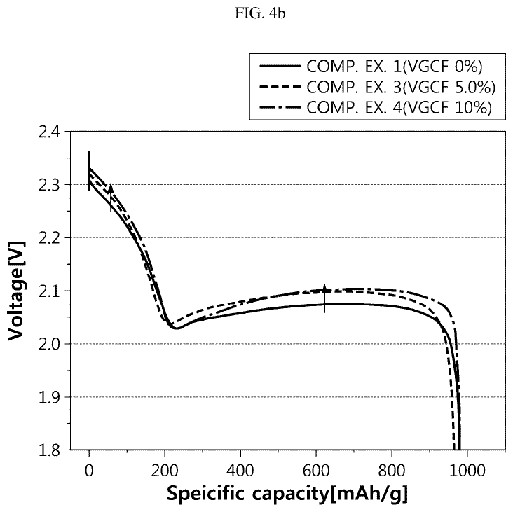

Meanwhile, as can be seen from FIGS. 2 and 3, it was confirmed that when only VCGF was used as the conductive material as in comparative examples 2 and 3 or only dispersed CNT was used as in comparative examples 4 and 5, the specific resistance reduction was prevented according to the added amount. Accordingly, when only VGCF is used 2.5% as in comparative example 2 shown in FIGS. 4a and 4b, the output is improved. However, it can be seen that when VGCF is included in the amount of 10 wt % which is more than 5 wt % as in comparative example 4, there is almost no additional output improvement effect compared to when VGCF is included in the amount of 5 wt %.

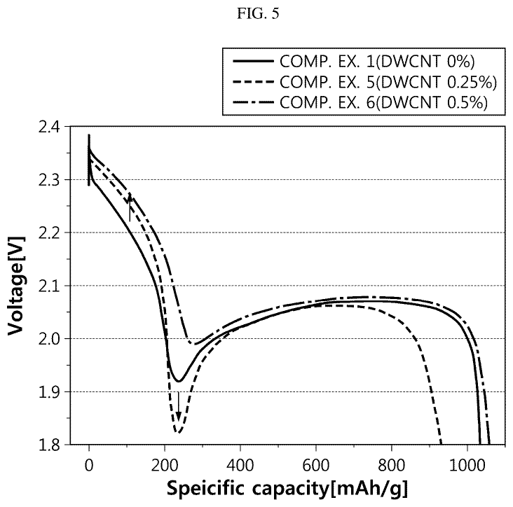

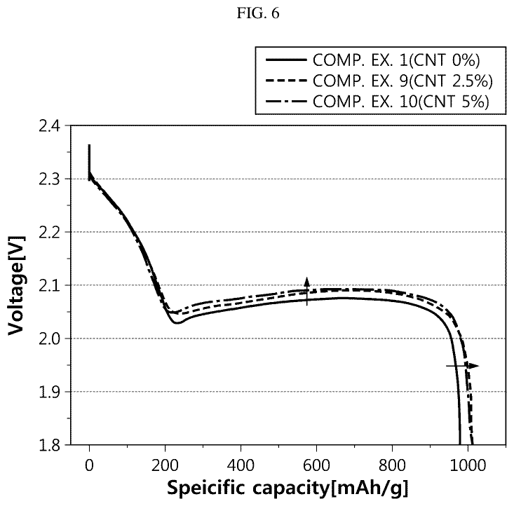

Additionally, as shown in FIG. 5, when dispersed CNT is used 0.25% as in comparative example 5, the output in the middle/at the end is improved, but when dispersed CNT is used 0.5% as in comparative example 6, the output in the middle/at the end decreases. Additionally, as shown in FIG. 6, the use of non-dispersed CNT particles improves the capacity and output at the end, but does not improve the output at the start.

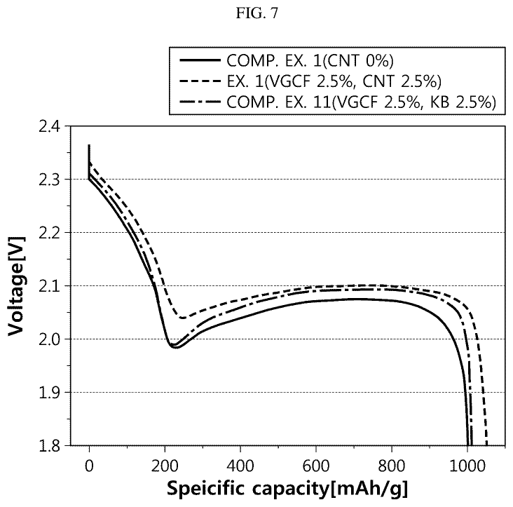

Meanwhile, as shown in FIG. 7, it can be seen that comparative example 1 without CNT and comparative example 11 using ketjen black as the second conductive material have almost no improvement effect of specific resistance and capacity compared to example 1.

### Experimental Example 1. Particle Size Measurement Method

The particle size corresponding to D₅₀ was measured by a dry method using a particle size analyzer (model name: Bluewave, manufacturer: Microtrac). When the carbon material comprises secondary particles by agglomeration of primary particles, the particle size of the primary particles was observed and measured using SEM (model name: SEM, manufacturer: JEOL)

### Experimental Example 2. Measurement of Discharge Characteristics

Each battery of example and comparative example was discharged at 0.2C in CC mode at 25° C. until 1.8V, and charged with 0.2C constant current until 2.5V, and the discharge capacity was measured and compared. The discharge capacity was measured based on the sulfur content (mAh/g(S)).

### Experimental Example 3. Measurement of Specific Electrode Resistance

The specific electrode resistance was measured using Hioki RM 2610. Specifically, the specific resistance was measured by bringing the manufactured electrode into contact with a multi electrode array of the machine, and a specific resistance value of an electrode layer was obtained from the measurement results.

1. A positive electrode material composition comprising
a positive electrode active material, a conductive material, and a binder material,
wherein the positive electrode active material comprises a sulfur-carbon composite comprising a porous carbon material and sulfur (S),
wherein the conductive material comprises a first conductive material and a second conductive material,
wherein the first conductive material comprises fibers having an average particle size of 5 μm or less,
wherein the second conductive material comprises secondary particles, including agglomerates of two or more primary particles of carbon nanotubes (CNT), and an average particle size of the second conductive material is 10 μm to 70 μm, and
wherein the positive electrode active material is included in a range between 80 and 97 wt %, the conductive material is included in a range between 2 wt % and 10 wt %, and the binder material is included in a range between 2 wt % and 10 wt %.

2. The positive electrode material composition according to claim 1, wherein the first conductive material comprises CNT, and an average number of walls of the CNT of the first conductive material is 1 to 20.

3. The positive electrode material composition according to claim 2, wherein the first conductive material comprises the CNT, and the first conductive material is included in an amount of 0.1 wt % to 0.5 wt % based on a total weight of the positive electrode active material, the binder material, and the conductive material.

4. The positive electrode material composition according to claim 1, wherein the first conductive material comprises carbon fibers, and the carbon fibers have a diameter of 100 nm to 2 μm.

5. The positive electrode material composition according to claim 1, wherein an average number of walls of the CNT of the second conductive material is 1 to 20, and
wherein an average diameter of the primary particles of the CNT is 0.4 nm to 100 nm.

6. The positive electrode material composition according to claim 1, wherein the first conductive material is included in an amount of 0.1 wt % to 5 wt % and the second conductive material is included in an amount of 1 wt % to 5 wt % based on a total weight of the positive electrode active material, the binder material, and the conductive material.

7. The positive electrode material composition according to claim 1, wherein the porous carbon material has a BET specific surface area of primary particles in a range between 100 m²/g and 3,000 m²/g.

8. The positive electrode material composition according to claim 1, wherein the porous carbon material comprises one or more selected from the group consisting of activated carbon, CNT, and graphene.

9. The positive electrode material composition according to claim 8,
wherein the porous carbon material comprises the CNT, and an average number of walls of the CNT of the porous carbon material is 1 to 20.

10. The positive electrode material composition according to claim 1, wherein the sulfur-carbon composite is included in an amount of 70 wt % or more based on 100 wt % of the positive electrode active material.

11. The positive electrode material composition according to claim 10, wherein the sulfur is included in an amount of 70 wt % or more based on 100 wt % of the sulfur-carbon composite.

12. The positive electrode material composition according to claim 1, wherein the sulfur-carbon composite has one or more of a composite in which the sulfur and the porous carbon material are simply mixed, a coated core-shell structure, or a structure of the porous carbon material with the sulfur loaded in pores thereof.

13. A positive electrode for an electrochemical device, the positive electrode comprising:
the positive electrode material composition according to claim 1.

14. (canceled)

15. A method for preparing a positive electrode slurry, comprising
mixing the positive electrode material composition according to claim 1 with a second solvent,
wherein the first conductive material is added in a state where its average particle size is controlled to be 5 μm or less, and
wherein the second conductive material is added in powder state.

16. The method according to claim 15, wherein the second solvent comprises one or more selected from water and an organic solvent.

17. The method according to claim 15, wherein when the first conductive material comprises CNT, the CNT of the first conductive material is fed into the slurry in a form of a mixed solution in which the CNT of the first conductive material is mixed with a first solvent.
